(19) United States
(12) Patent Application Publication
(10) Pub. No.: US 2013/0143074 A1
(43) Pub. Date: Jun. 6, 2013

(54) BATTERY PACK AND METHOD OF MANUFACTURING THE SAME

(71) Applicant: Yeungki KIM, Yongin-si (KR)

(72) Inventor: Yeungki KIM, Yongin-si (KR)

(73) Assignee: SAMSUNG SDI CO., LTD., Yongin-si (KR)

(21) Appl. No.: 13/533,710

(22) Filed: Jun. 26, 2012

(30) Foreign Application Priority Data
Dec. 2, 2011 (KR) 10-2011-0128670

(51) Int. Cl. H01M 2/00; B29C 45/14; H01M 10/50

(52) U.S. Cl. 429/7; 264/272.21; 264/255

(57) ABSTRACT

Disclosed are a battery pack and a method of manufacturing the same, in which a case accommodating a core pack including a bare cell and a protection circuit member is integrally formed as a single body by using a foam, thereby improving impact resistance of the core pack and improving working efficiency and productivity without the need of an adhesive coating step. The battery pack includes a core pack including a bare cell and a protection circuit member attached to one side of the bare cell, a case formed of a foam and accommodating the core pack, and a shielding layer formed on a surface of the protection circuit member.

### CLAIM OF PRIORITY

This application makes reference to, incorporates the same herein, and claims all benefits accruing under 35 U.S.C. §119 from an application for BATTERY PACK AND METHOD OF MANUFACTURING THEREOF earlier filed in the Korean Intellectual Property Office on Dec. 2, 2011 and there duly assigned Korean Patent Application No. 10-2011-0128670.

### BACKGROUND OF THE INVENTION

1. Field of the Invention

Embodiments of the present invention relate to a battery pack and a method of manufacturing the same, and more particularly, to a battery pack and a method of manufacturing the same improving impact resistance of a core pack and improving working efficiency and productivity of the battery pack without the need of an adhesive coating step.

2. Description of the Related Art

In general, a battery pack includes a rechargeable bare cell and a protection circuit module that prevents the bare cell from being over-charged or over-discharged. Recently, lithium ion batteries or lithium polymer batteries have been increasingly used as the bare cell. In addition, the protection circuit module includes a plurality of circuit elements for preventing over-charge or over-discharge of the bare cell.

The battery pack is formed by connecting the protection circuit module to the outside of the bare cell, accommodating the protection circuit module and the bare cell in a case having divided parts adhered to each other, and welding dividing surfaces of the case to each other.

When the dividing surfaces of the case are welded to each other, however, the welding procedure is achieved by using heat generated due to vibration caused by applying ultrasound or radio-frequency waves to the dividing surfaces of the case. Such vibration may dislocate the protection circuit module and a plurality of circuit elements included in the protection circuit module. Further, the bare cell disposed within the case may be damaged due to external impacts, for example, the external impacts caused by such vibration.

### SUMMARY OF THE INVENTION

Embodiments of the present invention provide a battery pack and a method of manufacturing the same, in which a case accommodating a core pack including a bare cell and a protection circuit member is integrally formed of a foam, thereby improving impact resistance of the core pack and improving working efficiency and productivity of the battery pack without the need of an adhesive coating step.

In accordance with one aspect of the present invention, a battery pack may include a core pack including a bare cell and a protection circuit member attached to one side of the bare cell, a case formed of a foam and accommodating the core pack, and a shielding layer formed on a surface of the protection circuit member.

The foam may be made of expanded polypropylene (EPP) or expanded polystyrene (EPS).

The shielding layer may be made of an insulating material.

The insulating material may be one selected from the group consisting of a thermal insulation material made of glass wool, a thermal insulation material made of rock wool, polyurethane foam, vermiculite and perlite (pearl stone).

The battery pack may further include a heat dissipation layer between the protection circuit member and the shielding layer.

The heat dissipation layer may be made of a material having a higher heat transfer rate than that of the foam.

The heat dissipation layer may be made of a copper alloy material.

The battery pack may further include a coupling unit formed at one side of the case to be coupled and fixed to an external device.

The coupling unit may be formed of a foam having a higher mechanical strength than that of the foam forming the case.

The coupling unit may be made of steel or plastic.

In accordance with another aspect of the present invention, a method of manufacturing a battery pack may include steps of forming a shielding layer on a surface of a protection circuit member which is attached to one side of a bare cell, providing a mold formed to geometrically correspond to external shapes of the bare cell and the protection circuit member, injecting a foam into the inside of the mold, and integrally and simultaneously forming a case as a single body between each of the bare cell, the protection circuit member and the mold by foam-molding the foam.

Before the step of forming of the shielding layer, the method may further include a step of forming a heat dissipation layer on the protection circuit member.

After the step of the forming of the case, the method may further include a step of forming a coupling unit at one side of the case coupled to an external device.

In accordance with still another aspect of the present invention, a method of manufacturing a battery pack may include steps of forming a shielding layer on a surface of a protection circuit member attached to one side of a bare cell, providing a mold formed to geometrically correspond to external shapes of the bare cell and the protection circuit member, firstly injecting a first foam into a region within the mold where a coupling unit formed at another side of the bare cell is located, secondly injecting a second foam into regions within the mold where the bare cell and the protection circuit member are located, and integrally and simultaneously forming a case as a single body between each of the bare cell, the protection circuit member and the mold by foam-molding the first and second foams.

The first foam may be a foam having a higher mechanical strength than that of the second foam.

As described above, in the battery pack and the method of manufacturing the same, a case accommodating a core pack including a bare cell and a protection circuit member is integrally formed using a foam, thereby improving impact resistance of the core pack and improving working efficiency and productivity without the need of an adhesive coating step.

In addition, in accordance with the embodiment of the present invention, the case is integrally formed, thereby reducing the manufacturing cost, compared to the conventional battery pack having an upper case and a lower case.

Further, in accordance with the embodiment of the present invention, a shielding layer is formed in a protection circuit member, thereby preventing the protection circuit member from being damaged when forming the case using a foam.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1A is an oblique view of a battery pack constructed with an embodiment of the present invention;

FIG. 1B is an exploded cross-sectional view of the battery pack shown in FIG. 1A;

FIG. 2 is a cross-sectional view taken along the line I-I′ of FIG. 1A;

FIG. 3 is an enlarged view of an ‘A’ portion of FIG. 2;

FIG. 4 illustrates another embodiment of the ‘A’ portion of FIG. 2;

FIG. 5 is a circuit view of a protection circuit unit in the ‘A’ portion of FIG. 2;

FIGS. 6A through 6C illustrate a method of manufacturing a battery pack constructed with an embodiment of the present invention;

FIG. 7 is a flowchart illustrating a method of manufacturing a battery pack constructed with another embodiment of the present invention; and

FIG. 8 is a flowchart illustrating a method of manufacturing a battery pack constructed with still another embodiment of the present invention.

### DETAILED DESCRIPTION OF THE INVENTION

Hereinafter, embodiments of embodiments of the invention will be described in detail with reference to the accompanying drawings such that they can easily be made and used by those skilled in the art.

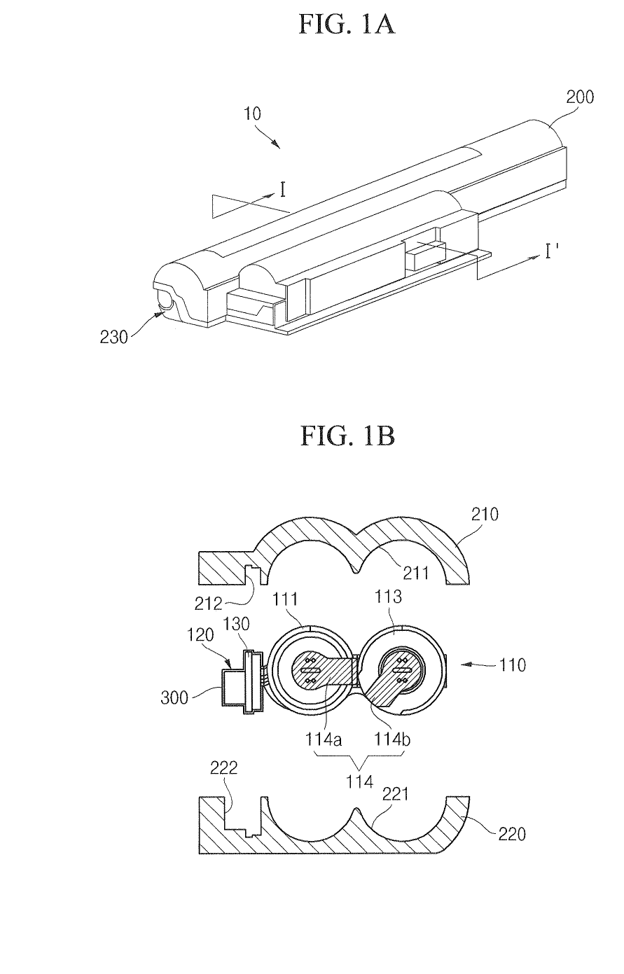

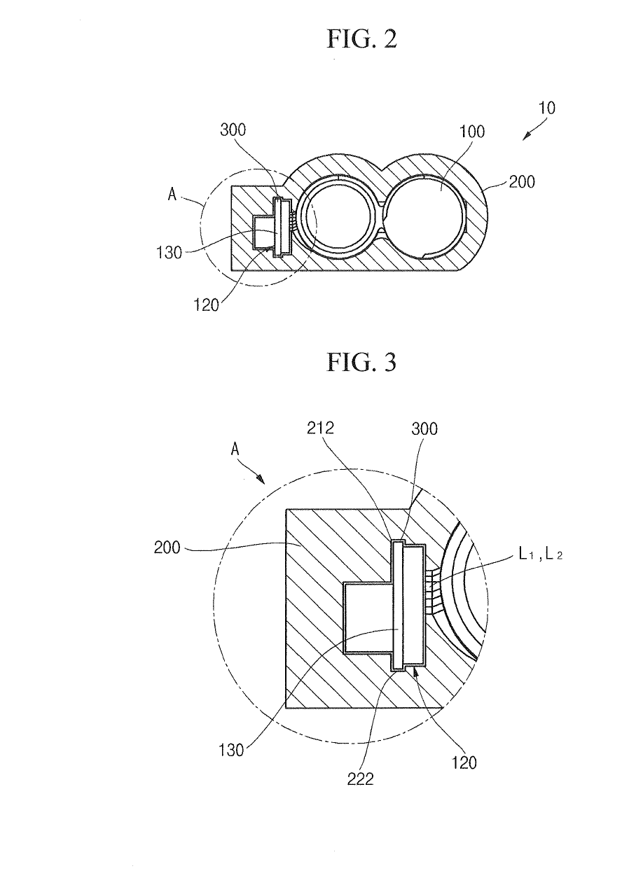

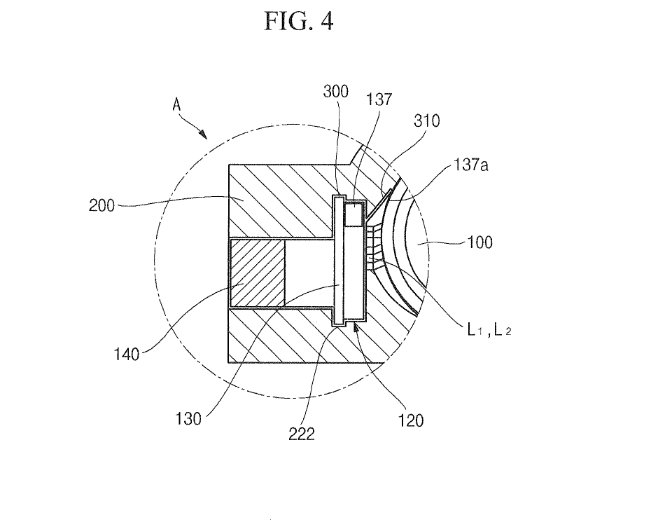

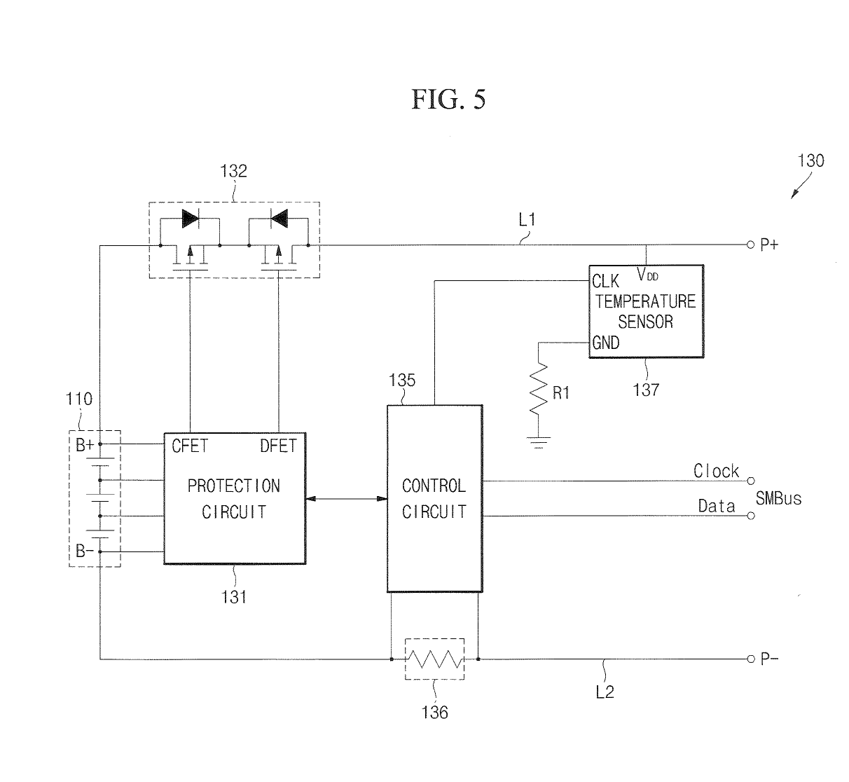

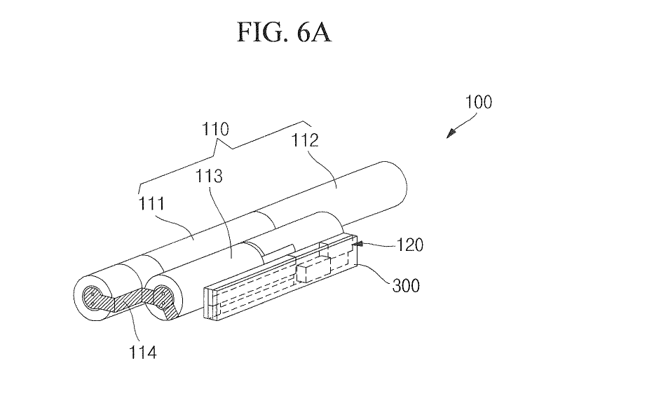

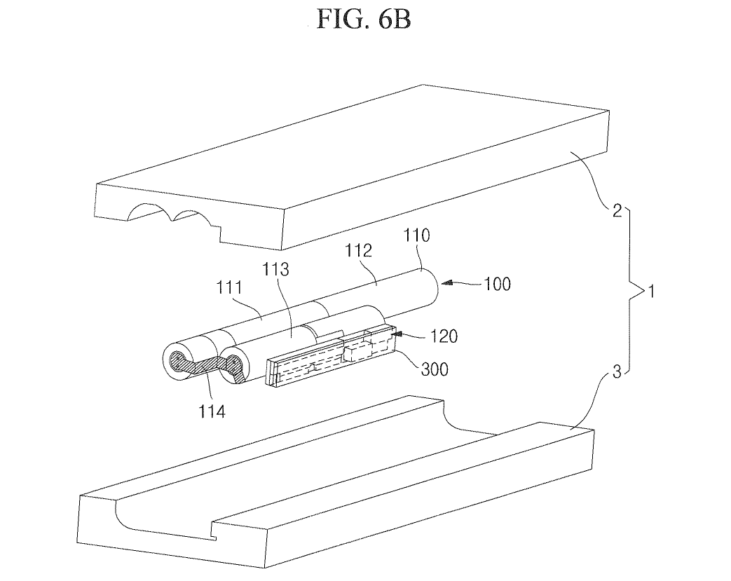

FIG. 1A is an oblique view of a battery pack constructed with an embodiment of the present invention, FIG. 1B is an exploded cross-sectional view of the battery pack shown in FIG. 1A, FIG. 2 is a cross-sectional view taken along the line I-I ′ of FIG. 1A, FIG. 3 is an enlarged view of an ‘A’ portion of FIG. 2, FIG. 4 illustrates another embodiment of the ‘A’ portion of FIG. 2, and FIG. 5 is a circuit view of a protection circuit unit in the ‘A’ portion of FIG. 2.

Referring to FIGS. 1A through 5, the battery pack 10 constructed with an embodiment of the present invention includes a core pack 100, a case 200 and a shielding layer 300.

The core pack 100 includes a bare cell 110 and a protection circuit member 120 attached to one side of the bare cell 110. The bare cell 110 may be a prismatic battery or a cylindrical battery, and the following description will be made with regard to a cylindrical battery.

An electrode assembly (not shown) having a positive electrode plate, a negative electrode plate and a separator wound in a jelly-roll configuration is accommodated in the bare cell 110 forming the core pack 100. In addition, a can (not shown) sealed by a cap assembly (not shown) electrically connected to the electrode assembly is provided at a top portion of the bare cell 110. The can is formed of a substantially cylindrical metal case having a top opening.

The bare cell 110 forming the core pack 100 includes a plurality of bare cells 111, 112 and 113, which are connected to each other in series or in parallel. In addition, in consideration of capacity and size, the core pack 100 may be configured such that the plurality of bare cells 111, 112 and 113 may be arranged in two or more rows. The plurality of bare cells 111, 112 and 113 may be connected to each other in series or in parallel using electrode tabs 114. The bare cell 110 includes positive and negative electrode terminals (B+ and B−) (see FIG. 5.), which are electrically connected to positive and negative electrode connection terminals (not shown) of the protection circuit member 120 and pack-positive and negative electrode terminals (P+ and P−) of the core pack 100 (see FIG. 5.) through a first lead wire (L1) and a second lead wire (L2) (see FIGS. 3, 4 and 5).

In order to ensure the safety of a secondary battery, the protection circuit member 120 is electrically connected to exposed positive and negative electrode tabs of the plurality of bare cells 111, 112 and 113. That is to say, the protection circuit member 120 is disposed at one side of the plurality of bare cells 111, 112 and 113 and is electrically connected to the plurality of bare cells 111, 112 and 113, thereby forming the core pack 100. The present invention however does not limit the method of building electrical connection between the protection circuit member 120 and the plurality of bare cells 111, 112 and 113 to that illustrated herein, various electrical connection methods may be used according to the shapes of the bare cell 110 and the protection circuit member 120.

In addition, as shown in FIG. 5, a printed circuit board 130 of the protection circuit member 120 includes a charge/discharge switch unit 132 for charging and discharging the secondary battery, a control circuit 135 for controlling the charge/discharge switch unit 132 to be driven to make charged states uniform, and a protection circuit 131 for preventing over-discharge and over-charge. In addition, a protection element 137 such as a thermistor or a temperature fuse may be mounted on the printed circuit board 130. When a voltage and a current of the secondary battery exceed predetermined levels due to an increase in the internal temperature of the secondary battery or over-charge and over- discharge, a risk of rupture or firing of the secondary battery may be prevented by interrupting the flow of current.

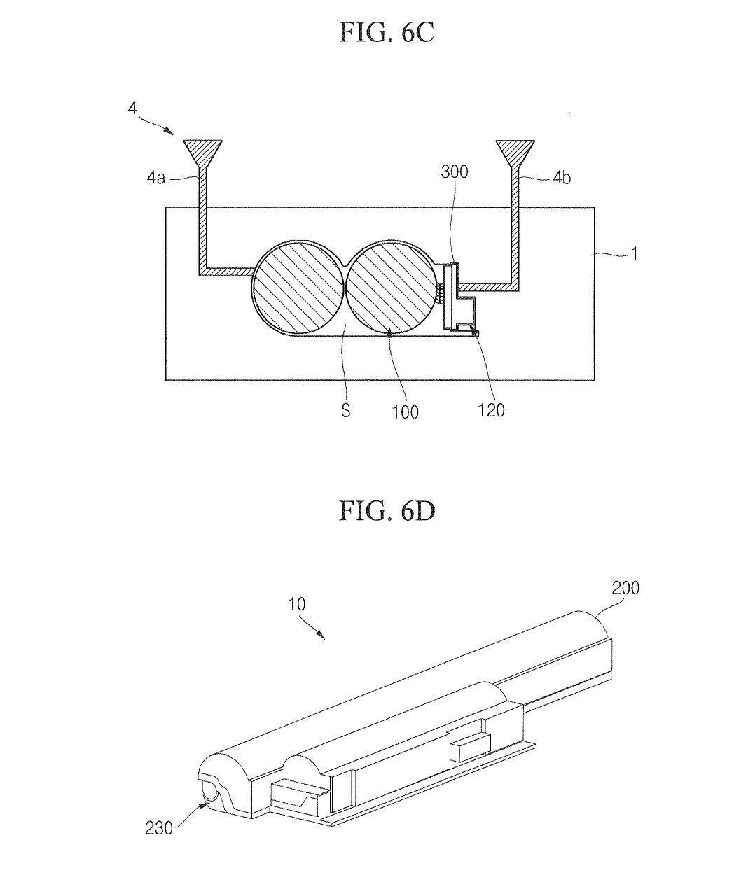

The case 200 is formed of a foam, which is molded to correspond to the external shape of the core pack 100 and to accommodate the core pack 100. That is to say, the case 200 is formed by foam-molding the foam at a predetermined temperature by injecting the foam into a mold 1 (see FIG. 6B) having a shape (212, 222 of FIGS. 1B and 3) corresponding to the external shape of the core pack 100 and surrounding the core pack 100.

Here, the foam may be made of expanded polypropylene (EPP) or expanded polystyrene (EPS). In one embodiment, the case 200 may include parts 210, 220, 211, 221, 212 and 222 as shown in FIG. 1B. The case 200 includes a first case 210 having a shape corresponding to the upper shape of the core pack 100 and a second case 220 having a shape corresponding to the lower shape of the core pack 100. The first case 210 has parts 211, 212 corresponding to the upper shape of the bare cell 110 and the printed circuit board 130. The second case 220 has parts 221, 222 corresponding to the lower shape of the bare cell 110 and the printed circuit board 130.

Expanded polypropylene may be a thermoplastic resin obtained by polymerizing propylene. Polypropylene is injected into the mold 1 (see FIG. 6B) and is foam-molded into spherical beads at a temperature of approximately 110° C. to 165° C. without using a chemical foam, thereby forming the case 200 accommodating the core pack 100.

In addition, expanded polystyrene may be a thermoplastic resin obtained by polymerizing styrene. A foam, such as pentane or butane gas, is injected into styrene and polymerized with water, and is then injected into the mold 1 and foam-molded into spherical beads at a temperature of approximately 100° C. to 185° C., thereby forming the case 200 accommodating the core pack 100.

Since the expanded polypropylene or the expanded polystyrene is foam-molded into spherical beads, it provides higher thermal insulation between beads and tenacity. In addition, since the expanded polypropylene or the expanded polystyrene has a low-density structure, it has excellent impact resistance and is light in weight. Therefore, in the present invention, the case 200 is integrally and simultaneously formed as a single body through foam-molding into the expanded polypropylene or expanded polystyrene, thereby imparting impact resistance to the case 200. In addition, in comparison with a plastic material forming the conventional case, the expanded polypropylene or expanded polystyrene is formed at a lower cost and is lighter in weight. Therefore, the cost of manufacturing the case 200 may be reduced while reducing the overall weight of the battery pack.

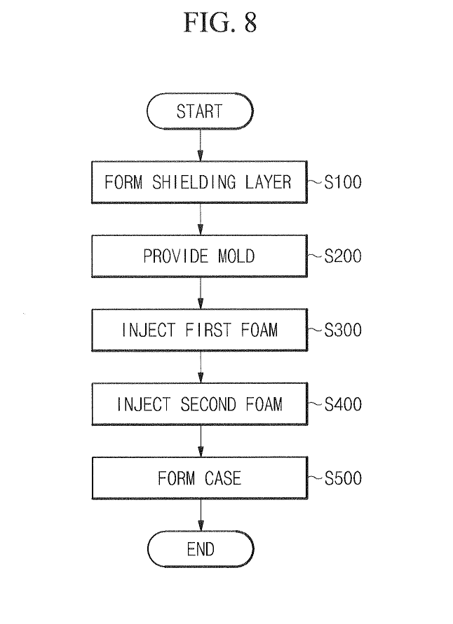

In addition, a coupling unit 230 (see FIG. 1) is formed at one side of the case 200 to be coupled and fixed to an external device. The coupling unit 230 protrudes from one side of the case 200, for example, from an upper side, from a lower side, or from both of the upper and lower sides, to be coupled to the external device employing the core pack 100. Here, the external device may be a notebook computer, a personal digital assistant (PDA), a cellular phone or a digital camera. Therefore, the coupling unit 230 is preferably formed of a foam having a higher mechanical strength than a foam forming the case 200 so as to be firmly coupled and fixed to the external device. Here, the foam having a higher mechanical strength than the foam forming the case 200 is a material formed to have a higher strength by varying pore sizes or crosslinking degrees of the foam by adjusting water or auxiliary foam included in the foam forming the case 200. In another embodiment, the coupling unit 230 may be is made of steel or plastic having a higher strength so as to be firmly coupled and fixed to the external device. The coupling unit 230 may be installed in the case 200 through an additional process after the formation of the case 200; alternatively, the coupling unit 230 may be formed integrally and simultaneously with the case 200 as a single body by expansion-molding. The formation of the coupling unit 230 will be described in more detail with reference to FIG. 8.

In the protection circuit member 120, as shown in FIG. 5, electric devices sensitive to heat, such as the control circuit 135 for controlling the charge/discharge switch unit 132 to be driven to make charged states uniform, the protection circuit 131 for preventing over-discharge and over-charge, the charge/discharge switch unit 132 including a charging switch 133 and a discharging switch 134, a temperature sensor 137, or a sense register 136 for sensing over-current, are installed on the printed circuit board 130 of the protection circuit member 120. Meanwhile, operations of these electric devices may be severely affected by the heat supplied when foams such as the expanded polypropylene or the expanded polystyrene are injected into the mold 1 and are entirely expanded. Therefore, in accordance with the present invention, in order to maintain the safety of the electric devices, these electric devices may be protected from the heat applied during the foam-molding by forming the shielding layer 300 on a surface of the protection circuit member 120 including these electric devices. In the illustrated embodiment of the present invention, the shielding layer 300 may be formed on the surface of the protection circuit member 120, the invention however does not limit a location where the shielding layer 300 is formed to that illustrated herein. In another embodiment, the shielding layer 300 may be formed on a surface of the electric devices or the printed circuit board 130 of the protection circuit member 120. In another embodiment, the shielding layer 300 may cover the entirety of the printed circuit member 120.

The shielding layer 300, which is formed on the surface of the protection circuit member 120, protects the protection circuit member 120 from heat. The shielding layer 300 may be formed of an insulating material. The insulating material is one selected from the group consisting of a thermal insulation material made of glass wool, a thermal insulation material made of rock wool, polyurethane foam, vermiculite and perlite (pearl stone). Therefore, the shielding layer 300, which is formed of an insulating material, prevents heat supplied when the foams injected into the mold 1 are foam-molded from being transferred to the protection circuit member 120.

Meanwhile, FIG. 4 illustrates that the temperature sensor 137 is connected to the printed circuit board 130 of the protection circuit member 120 through a separate conductive line 137a to then be installed on an outer surface of the bare cell 110, but the invention does not limit an installing method of the temperature sensor 137 to that illustrated herein. If the temperature sensor 137 is installed on the outer surface of the bare cell 100, a shielding layer 310 is formed on the conductive line 137a connecting the temperature sensor 137 and the printed circuit board 130.

Meanwhile, a heat dissipation layer 140 may be formed between the protection circuit member 120 and the shielding layer 300. The heat dissipation layer 140 discharges the heat generated by the operations of the electric devices installed on the printed circuit board 130 of the protection circuit member 120. In one embodiment, a heat dissipation layer 140 may be formed in immediate physical contact with both of the protection circuit member 120 and the shielding layer 300.

Here, the heat dissipation layer 140 may be made of a copper alloy material having a higher thermal conductivity than the foam such as the expanded polypropylene or the expanded polystyrene. For example, the copper alloy material may include HR750 or S55C. However, the present invention does not limit the kind of the copper alloy material.

Therefore, according to the present invention, the heat generated at the electric devices installed on the printed circuit board 130 of the protection circuit member 120 may be effectively discharged to the outside by forming the heat dissipation layer 140 using the copper alloy material having a high thermal conductivity. In addition, it is also possible to prevent these electric devices from being damaged due to the generated heat, thereby preventing malfunctioning of the electric devices and extending life spans of the electric devices.

FIGS. 6A through 6C illustrate a method of manufacturing a battery pack constructed with an embodiment of the present invention.

Referring to FIG. 6A, in order to manufacture a battery pack constructed with an embodiment of the present invention, a core pack 100, including a bare cell 110 and a protection circuit member 120 attached to one side of the bare cell 110, is first prepared. Here, the bare cell 110 forming the core pack 100 includes a plurality of bare cells 111, 112 and 113, which are connected to each other in series through electrode tabs 114. In addition, a shielding layer 300 made of an insulating material is formed on a surface of the protection circuit member 120.

Referring to FIG. 6B, an upper mold 2 shaped to correspond to a top outer surface of the core pack 100 and a lower mold 3 shaped to correspond to a bottom outer surface of the core pack 100 are disposed on and under the core pack 100. Then, the upper mold 2 and the lower mold 3 are closely adhered to the top and bottom outer surfaces of the core pack 100, thereby combining the upper mold 2 and the lower mold 3 with each other by means of a predetermined fastening means (not shown). Here, the upper mold 2 and the lower mold 3 are spaced apart by a predetermined distance from the top and bottom outer surfaces of the core pack 100, thereby forming a space S (see FIG. 6C) in which the case 20 is molded. In addition, in order to increase packing efficiency of the foams, it is preferable to make the space vacuous using, for example, a vacuum pump. As described above, if the space is made vacuous, flowability of the foams is improved when the foams are injected, thereby increasing the packing efficiency of the foams is increased.

Referring to FIG. 6C, the foams are injected into the space S formed between the upper and lower molds 2 and 3 and the top and bottom outer surfaces of the core pack 100 through foam inlets 4a and 4b formed at one side or both sides of the combined upper and lower molds 2 and 3 and connected to an external foam injection apparatus 4. The foams injected into the space S are in close contact with the top and bottom outer surfaces of the core pack 100 and are evenly injected into the space S in an amount corresponding to the volume of the space. In one embodiment, the space S may surround the entire core pack 100.

Referring to FIG. 6D, if the foams are evenly packed into the space formed between the upper and lower molds 2 and 3 and the top and bottom outer surfaces of the core pack 100, and the foam-molding is completed in the upper mold 2 and the lower mold 3, the foam inlets 4a and 4b are separated from the upper mold 2 and the lower mold 3, and the upper mold 2 and the lower mold 3 are disassembled. Through the above-described processes, the integral case 200 having the core pack 100 accommodated therein is formed, thereby completing a unit battery pack 10.

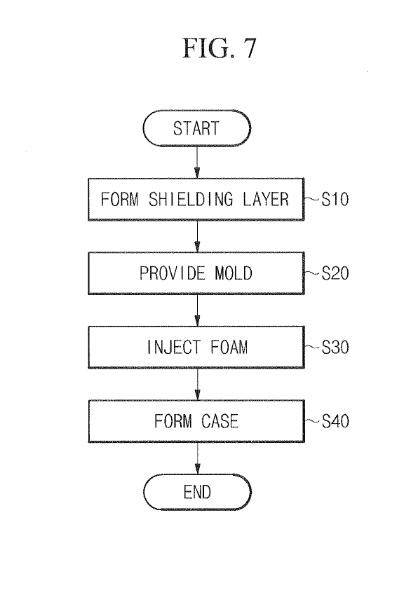

FIG. 7 is a flowchart illustrating a method of manufacturing a battery pack constructed with another embodiment of the present invention.

Referring to FIG. 7, the method of manufacturing a battery pack constructed with another embodiment of the present invention includes forming a shielding layer on a surface of a protection circuit member attached to one side of the bare cell (S10), providing a mold shaped to correspond to the external shapes of the bare cell and the protection circuit member (S20); injecting foams into the mold (S30), and forming an integral case between each of the bare cell, the protection circuit member and the mold by foam-molding the foams (S40). The case is integrally and simultaneously formed as a single body by molding foams injected into the space S formed between the upper and lower molds 2 and 3 and the top and bottom outer surfaces of the core pack 100.

Before the forming of the shielding layer (S10), although not shown, the method of manufacturing a battery pack constructed with another embodiment of the present invention may further include forming a heat dissipation layer on the protection circuit member.

After the forming of the case (S40), although not shown, the method of manufacturing a battery pack constructed with another embodiment of the present invention may further include forming a coupling unit at one side of the case to be coupled and fixed to an external device.

FIG. 8 is a flowchart illustrating a method of manufacturing a battery pack constructed with still another embodiment of the present invention. In FIG. 8, the coupling unit is formed by dual foaming, unlike in FIG. 7.

Referring to FIG. 8, the method of manufacturing a battery pack constructed with still another embodiment of the present invention includes forming a shielding layer on a surface of a protection circuit member attached to one side of the bare cell (S100), providing a mold shaped to correspond to the external shapes of the bare cell and the protection circuit member (S200), injecting first foams into a region of a coupling unit formed at another side of the bare cell in the mold (S300), injecting second foams into regions where the bare cell and the protection circuit member are located in the mold (S400), and forming an integral case between each of the bare cell, the protection circuit member and the molds by foam-molding the first and second foams (S500).

In the injecting of the first foam (S300), a separate shielding layer is installed at a region where the bare cell and the protection circuit member are located, and the first foam is injected into the region of the coupling unit 230 formed at another side of the bare cell. Next, after the injecting of the first foam (S300), in the injecting of the second foam (S400), the second foam is injected into regions where the bare cell and the protection circuit member are located.

Here, the first foam has a higher mechanical strength than the second foam.

In the aforementioned battery pack and the method of manufacturing the same according to the present invention, a case accommodating a core pack including a bare cell and a protection circuit member is integrally formed as a single body using a foam, thereby improving shock resistance of the core pack and improving working efficiency and productivity. In addition, since a shielding layer is formed on the protection circuit member, it is possible to prevent the protection circuit member from being damaged when the case is formed using the foam, and the product reliability may be improved.

Exemplary embodiments of a battery pack and a method of manufacturing the same have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A battery pack, comprising:
a core pack comprising a bare cell and a protection circuit member attached to one side of the bare cell;
a case formed of a first foam and accommodating an entirety of the core pack; and
a shielding layer formed to cover an entirety of the protection circuit member.

2. The battery pack of claim 1, wherein the first foam is made of one of expanded polypropylene (EPP) and expanded polystyrene (EPS).

3. The battery pack of claim 1, wherein the shielding layer is made of an insulating material.

4. The battery pack of claim 3, wherein the insulating material is one selected from the group consisting of a thermal insulation material made of glass wool, a thermal insulation material made of rock wool, polyurethane foam, vermiculite and perlite (pearl stone).

5. The battery pack of claim 1, further comprising a heat dissipation layer disposed between the protection circuit member and the shielding layer.

6. The battery pack of claim 5, wherein the heat dissipation layer is made of a material having a higher heat transfer rate in comparison with that of the first foam.

7. The battery pack of claim 5, wherein the heat dissipation layer is made of a copper alloy material.

8. The battery pack of claim 1, further comprising a coupling unit formed at one side of the case to be coupled and fixed to an external device.

9. The battery pack of claim 8, wherein the coupling unit is formed of a second foam having a higher mechanical strength than the first foam forming the case.

10. The battery pack of claim 8, wherein the coupling unit is made of steel or plastic.

11. A method of manufacturing a battery pack, the method comprising:
forming a shielding layer to cover an entirety of a protection circuit member which is attached to one side of a bare cell;
providing a mold formed to geometrically correspond to external shapes of the bare cell and the protection circuit member;
injecting a foam into the inside of the mold; and
integrally and simultaneously forming a case as a single body between each of the bare cell, the protection circuit member and the mold by foam-molding the foam.

12. The method of claim 11, before the forming of the shielding layer, further comprising forming a heat dissipation layer on the protection circuit member.

13. The method of claim 11, after the forming of the case, further comprising forming a coupling unit formed at one side of the case with the coupling unit being coupled to an external device.

14. A method of manufacturing a battery pack, the method comprising:
forming a shielding layer on a surface of a protection circuit member attached to one side of a bare cell;
providing a mold formed to geometrically correspond to external shapes of the bare cell and the protection circuit member;
firstly injecting a first foam into a region within the mold where a coupling unit formed at another side of the bare cell are located;
secondly injecting a second foam into regions within the mold where the bare cell and the protection circuit member are located; and
integrally and simultaneously forming a case as a single body between each of the bare cell, the protection circuit member and the mold by foam-molding the first and second foams.

15. The method of claim 11, wherein the first foam is a foam having a higher mechanical strength in comparison with that of the second foam.
